(19) United States
(12) Patent Application Publication
(10) Pub. No.: US 2011/0087408 A1
(43) Pub. Date: Apr. 14, 2011

(54) TORQUE CONTROL DEVICE FOR INTERNAL COMBUSTION ENGINE

(75) Inventor: Koji Aso, Susono-shi (JP)

(73) Assignee: Toyota Jidosha Kabushiki Kaisha, Toyota-shi, Aichi-ken (JP)

(21) Appl. No.: 12/933,692

(22) PCT Filed: Feb. 18, 2009
(86) PCT No.: PCT/JP2009/053304

§ 371 Date: Dec. 8, 2010

(30) Foreign Application Priority Data
Mar. 24, 2008 (JP) 2008-075923

(51) Int. Cl. F16H 59/14

(52) U.S. Cl. 701/54

(57) ABSTRACT

In a torque control device for an internal combustion engine, a driving-system torque calculation unit calculates a driving-system torque operating on a driving system, based on a requested torque at a time of acceleration. A torque control unit executes torque control so that a gradient of the driving-system torque becomes equal to or smaller than a predetermined value, based on the driving-system torque calculated by the driving-system torque calculation unit. Thereby, since an amount of twist of the driving system can be maintained equal to or smaller than a predetermined value, repetitive shock can be suppressed, and acceleration shock can be effectively suppressed, too. Response deterioration and fuel consumption deterioration at the time of acceleration can be prevented.

### TECHNICAL FIELD

The present invention relates to torque control of an internal combustion engine in order to suppress shock occurring at a time of acceleration.

### BACKGROUND TECHNIQUE

A technique of this kind is described in Patent Reference 1, for example. In Patent Reference 1, there is disclosed a technique of executing phase delay control of ignition timing to suppress acceleration shock occurring due to a twisting vibration of a driving system (corresponding to a power transmission system which transmits output of the internal combustion engine to driving wheels) at the time of acceleration. In Patent Reference 2, there is disclosed a technique of predicting the twisting vibration in the driving system at the time of acceleration and executing control of throttle opening degree and ignition timing in order to suppress the predicted vibration component. In Patent Reference 3, there is disclosed a technique associated with the present invention.

In the techniques of Patent References 1 to 3, there is executed the control to make the torque of the internal combustion engine down, e.g., the phase delay control of the ignition timing and reduction of an fuel injection amount, on condition that the acceleration shock basically occurs. Therefore, response deterioration and fuel consumption deterioration sometimes occur at the time of acceleration.

Patent Reference 1: Japanese Patent Application Laid-open under No. H05-321803

Patent Reference 2: Japanese Patent Application Laid-open under No. 2004-68702

Patent Reference 3: Japanese Patent Application Laid-open under No. 2003-41987

### DISCLOSURE OF INVENTION

### Means for Solving the Problem

The present invention has been achieved in order to solve the above problem. It is an object of this invention to provide a torque control device for an internal combustion engine capable of preventing response deterioration and fuel consumption deterioration at a time of acceleration and capable of appropriately suppressing acceleration shock occurrence.

According to one aspect of the present invention, there is provided a torque control device for an internal combustion engine which controls a torque of an internal combustion engine mounted on a vehicle, including: a driving-system torque calculation unit which calculates a driving-system torque operating on a driving system for transmitting the torque of the internal combustion engine to driving wheels, based on a requested torque at a time of acceleration of the vehicle; and a torque control unit which controls the torque of the internal combustion engine so that a gradient of the driving-system torque becomes equal to or smaller than a predetermined value, based on the driving-system torque calculated by the driving-system torque calculation unit.

The above torque control device for the internal combustion engine is preferably used in order to suppress the shock occurring at the time of acceleration. Concretely, the driving-system torque calculation unit calculates the driving-system torque operation on the driving system for transmitting the torque of the internal combustion engine to the driving wheels, based on the requested torque at the time of acceleration. Based on the driving-system torque calculated by the driving-system torque calculation unit, the torque control unit executes the torque control so that the gradient of the driving-system torque becomes equal to or smaller than the predetermined value. By executing the control, it becomes possible to maintain the driving-system twisting amount equal to or smaller than the predetermined value. Therefore, it also becomes possible to suppress the repetitive shock and effectively suppress the acceleration shock. In addition, since the control to make the torque of the internal combustion engine down is not always executed on condition that the acceleration shock occurs, an ineffective time (i.e., the time at which the acceleration does not appropriately rise up in correspondence with an acceleration instruction) does not increase. Thus, it becomes possible to appropriately prevent the deterioration of the response to the acceleration request. Therefore, by the torque control device for the internal combustion engine, it becomes possible to prevent the response deterioration and the fuel consumption deterioration at the time of acceleration and appropriately suppress the occurrence of the acceleration shock.

In a manner of the above torque control device for the internal combustion engine, the torque control unit may control the torque of the internal combustion engine so that the gradient of the driving-system torque is limited to the predetermined value, when the gradient of the driving-system torque becomes larger than the predetermined value.

In another manner, the torque control device for the internal combustion engine further includes a change unit which changes the predetermined value in correspondence with a request of a driver. Thereby, the appropriate action corresponding to the drivability requested by the driver becomes possible. Namely, it becomes possible to appropriately change whether to give a priority to the suppression of the acceleration shock or to the improvement of the response to the acceleration request, in correspondence with the request of the driver. Thus, when a request which allows the acceleration shock and regards the response and the absolute speed performance important is given by the driver, the optimum action becomes possible.

Preferably, in the above torque control device for the internal combustion engine, the change unit may use an accelerator opening speed as the request of the driver, and may change the predetermined value in correspondence with the accelerator opening speed.

In addition, preferably, in the above torque control device for the internal combustion engine, the change unit may use a drive mode set by the driver as the request of the driver, and may change the predetermined value in correspondence with the drive mode.

Further preferably, the predetermined value may be the gradient of the driving-system torque corresponding to a maximum allowable amount of shock in a relation between the gradient of the driving-system torque obtained in advance and an amount of shock occurring at the time of acceleration. Thereby, the control of the torque control unit makes it possible to appropriately suppress the acceleration shock equal to or smaller than the maximum allowable shock amount. In addition, by determining the predetermined value based on the relation, it also becomes possible to reduce re-adaptation process at the time of design change of the driving system and at the time of producing a car model having the same power train.

In a preferred form, the driving system may be formed by a drive shaft. Namely, the torque operating on the drive shaft as the driving-system torque is used. In this case, the torque control unit manages the torque operating on the drive shaft which is weak against and susceptible to twist by executing the above-mentioned control.

### BRIEF DESCRIPTION OF THE DRAWINGS

FIG. 1 shows a schematic configuration diagram of a vehicle to which a torque control device for an internal combustion engine according to an embodiment is applied;

FIG. 2 shows a result in a case of executing control according to a comparative example;

FIG. 3 shows an example of a result in a case of executing control according to a first embodiment;

FIG. 4 shows an example of a map for setting a maximum allowable shaft torque gradient used in the control according to the first embodiment;

FIG. 5 is a diagram for explaining a method of changing a maximum allowable shaft torque gradient according to a second embodiment; and

FIG. 6 is a diagram for explaining a method of changing a maximum allowable shaft torque gradient according to a third embodiment.

### BRIEF DESCRIPTION OF THE REFERENCE NUMBER

1 Engine (Internal combustion engine)

2 Torque converter

3 Automatic transmission

4 Differential gear

5 Drive shaft

6 Wheel

11 Accelerator opening sensor

20 ECU

50 Vehicle

### DETAILED DESCRIPTION OF THE PREFERRED EMBODIMENTS

The preferred embodiments of the present invention will now be described below with reference to the attached drawings.

### [Entire Configuration]

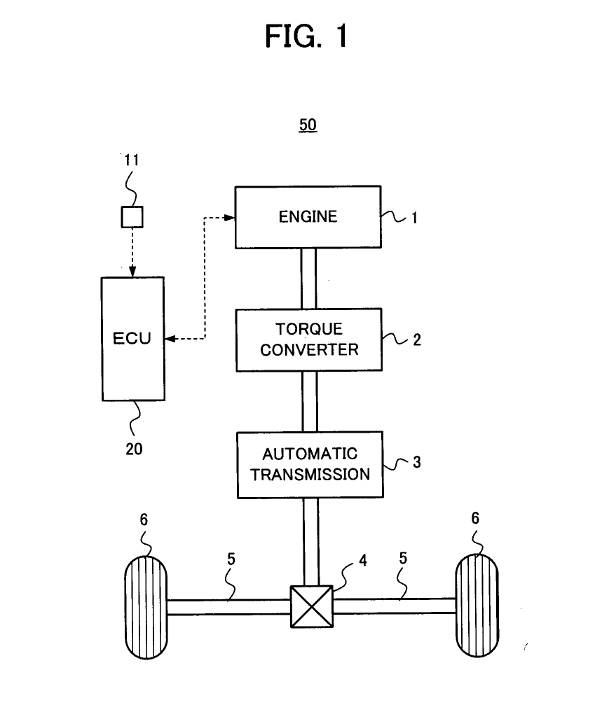

FIG. 1 shows a schematic configuration showing a configuration of a vehicle 50 to which the torque control device for the internal combustion engine according to an embodiment is applied. In FIG. 1, input/output of a signal is shown by broken-line arrows.

The vehicle 50 mainly includes an engine (internal combustion engine) 1, a torque converter 2, an automatic transmission 3, a differential gear 4, a drive shaft 5, wheels 6, an accelerator opening degree sensor 11 and an ECU (Engine Control Unit) 20.

The engine 1 outputs a main power of the vehicle 50 by combusting a mixture of fuel and intake air in a combustion chamber. The engine 1 transmits the outputted power to the torque converter 2 via a crank shaft (not shown). In the engine 1, control of various kinds is executed by control signals supplied from the ECU 20. For example, the torque control of the engine 1 is executed.

The torque converter 2 corresponds to a so-called hydrodynamic power transmission device. Concretely, the torque converter 2 includes a pump connected with the crank shaft of the engine 1, a turbine connected with an input shaft of the automatic transmission 3 and a lockup clutch which makes the crank shaft of the engine 1 and the input shaft of the automatic transmission 3 directly connected with each other.

The automatic transmission 3 is formed in a planetary gear type, and the power is transmitted from the torque converter 2 via the input shaft. Concretely, a gear stage (speed gear stage) of the automatic transmission 3 is set when a clutch component, a brake component and a one-way clutch component, being friction components, engage or are released in a predetermined state. The wheels 6 are connected to the output shaft of the automatic transmission 3 via the differential gear 4 and the drive shaft 5. The torque converter 2, the automatic transmission 3, the differential gear 4 and the drive shaft 5 correspond to the driving system for transmitting the output torque outputted from the engine 1 to the wheels 6.

The accelerator opening degree sensor 11 can detect the accelerator opening degree corresponding to the accelerator operation by the driver, and supplies, to the ECU 20, a detection signal corresponding to the detected accelerator opening degree.

The ECU 20 includes a CPU (Central Processing Unit), a ROM (Read Only Memory) and a RAM (Random Access Memory), which are not shown. The ECU 20 obtains the detection signal from various kinds of sensors (e.g., the accelerator opening degree sensor 11) provided on the vehicle 50, and executes the control of various kinds to components on the vehicle 50. In the embodiment, the ECU 20 mainly controls ignition timing and opening degree of a throttle valve, and thereby executes the control of the torque generated by in the engine 1. The ECU 20 corresponds to the torque control device for the internal combustion engine in the present invention. Concretely, the ECU 20 functions as the driving-system torque calculation unit, the torque control unit and the change unit. The ECU 20 also controls other components on the vehicle 50, but an explanation of a part which is not associated with this embodiment is omitted.

The vehicle 50 including the torque converter 2 and the automatic transmission 3 is described in the above explanation, but the present invention is not limited to the application to the vehicle 50 of this kind. Namely, the present invention is applicable to a vehicle including a Manual Transmission (MT).

### [Control Method]

Next, a description will be given of a control method executed by the above-mentioned ECU 20.

First, a description will be given of a basic concept of the control method according to this embodiment. In this embodiment, the ECU 20 executes the torque control of the engine 1 in order to appropriately suppress shock (acceleration shock) occurring at the time of acceleration. Concretely, at the time of acceleration, the ECU 20 obtains, from the requested torque, the driving-system torque operating on the driving system for transmitting the torque of the engine 1 to the driving wheels 6, and controls the torque of the engine 1 so that the gradient (corresponding to a differential value (i.e., a time change ratio)) of the driving-system torque becomes equal to or smaller than the predetermined value. Specifically, the ECU 20 obtains the torque operating on the drive shaft 5 (hereinafter referred to as “shaft torque”) from the requested torque, and controls the torque of the engine 1 so that the gradient of the shaft torque (hereinafter referred to as “shaft torque gradient”) becomes equal to or smaller than the predetermined value. The predetermined value is defined based on the relation between the shaft torque gradient obtained in advance and the amount of shock occurring at the time of acceleration.

The reason why the control is executed will be now explained. It is thought that the acceleration shock is significantly affected by the repetitive shock caused by the twist of the driving-system part, such as the drive shaft 5, which is relatively weak against and susceptible to the twist. Namely, as the twist of the driving-system part becomes larger, the returning amount also becomes larger, and hence the acceleration shock tends to become large. It is thought that the twist amount of the driving system part is uniquely determined by the gradient of the torque given to the driving system part such as the drive shaft. Hence, it is thought that there is a correlation between the torque gradient and the amount of the acceleration shock.

By the reason, the ECU 20 manages the torque (shaft torque) operating on the drive shaft 5 which is weak against and susceptible to the twist in this embodiment. Concretely, as described above, since it is thought that there is the correlation between the torque gradient and the amount of shock occurring at the time of acceleration, the ECU 20 manages the shaft torque so as to appropriately suppress the acceleration shock, based on the relation between the shaft torque gradient and the amount of shock. Specifically, the ECU 20 executes the torque control of the engine 1 in order to maintain the optimum shaft torque gradient determined by the amount of shock during the acceleration. Namely, the ECU 20 controls the torque of the engine 1 so that the shaft torque gradient becomes equal to or smaller than the shaft torque gradient corresponding to the maximum allowable amount of shock. By executing the control, it becomes possible to maintain the amount of twist of the drive shaft 5 at the approximately constant amount. Thus, it becomes possible to suppress the repetitive shock, and to effectively suppress the acceleration shock.

Hereinafter, the maximum allowable amount of shock is referred to as “aimed shock amount”, and the shaft torque gradient corresponding to the aimed shock amount is referred to as “maximum allowable shaft torque gradient” (the maximum allowable shaft torque gradient corresponds to the above-mentioned predetermined value). In this case, the maximum allowable shaft torque gradient is the shaft torque gradient corresponding to the aimed shock amount in the relation between the gradient of the shaft torque and the amount of shock.

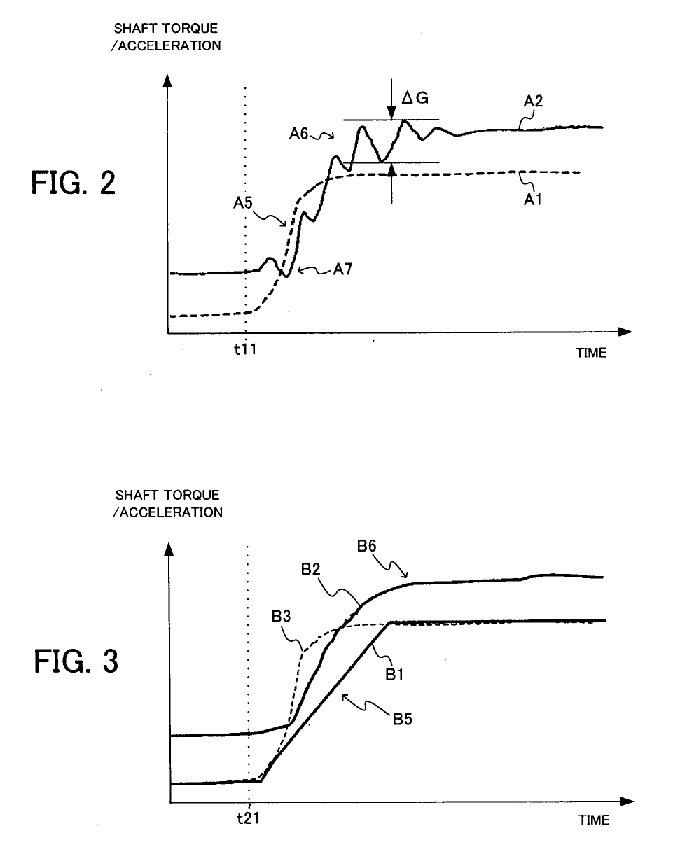

Now, the case of executing the control according to a comparative example and the case of executing the control according to this embodiment will be compared, with reference to FIG. 2. FIG. 2 shows the result of the case of executing the control according to the comparative example. The comparative example is to execute the control for predicting a vibration component occurring to the vehicle and making the torque of the engine 1 down to suppress the predicted vibration component. In FIG. 2, a graph shown by a broken line A1 shows a time variation of the shaft torque in such a case that the control according to the comparative example is executed, and a graph shown by an actual line A2 shows an acceleration waveform in such a case that the control according to the comparative example is executed. In addition, it is prescribed that the driver gives an acceleration instruction at time t11.

In FIG. 2, it is understood that the shaft torque sharply rises up, as shown by an arrow A5. Also, it is understood that the repetitive acceleration shock occurs, as shown by an arrow A6. At the same time, it is understood that a time (hereinafter referred to as “ineffective time”) at which the acceleration does not appropriately rise up in correspondence with the acceleration instruction is long, as shown by an arrow A7. Namely, it is understood that the response to the acceleration request is bad. When the acceleration is varied, the ineffective time tends to increase, as shown by the arrow A7. In this SPECIFICATION, a difference between a top part level and a bottom part level of the acceleration waveform at the time of occurrence of the acceleration shock is defined as a shock amount ΔG.

As compared with the above-mentioned comparative example, in this embodiment, the control of making the torque of the engine 1 down on condition that the acceleration shock occurs is not executed. Namely, in this embodiment, the torque control of the engine 1 is executed so that the shaft torque gradient is maintained equal to or smaller than the maximum allowable shaft torque gradient during the acceleration. Therefore, unlike the comparative example, the ineffective time is not increased by the control according to this embodiment. Hence, it becomes possible to effectively prevent the response deterioration. It also becomes possible to appropriately suppress the occurrence of the acceleration shock.

Now, a concrete description will be given of the embodiments of the control executed by the ECU 20.

### FIRST EMBODIMENT

In a first embodiment, the ECU 20 obtains the shaft torque from the requested torque at the time of acceleration. Then, when the shaft torque gradient becomes larger than the predetermined value (i.e., the maximum allowable shaft torque gradient), the ECU 20 executes the torque control of the engine 1 so that the shaft torque gradient is limited to the maximum allowable shaft torque gradient. Concretely, the ECU 20 calculates the requested torque based on the acceleration instruction of the driver, which is obtained by the accelerator opening degree sensor 11, and obtains the shaft torque in consideration of the requested torque, the gear stage of the automatic transmission 3 and the gear ratio of the differential gear 4. Then, the ECU 20 obtains the shaft torque gradient from the shaft torque, which corresponds to observing the shaft torque and obtaining the shaft torque gradient. When the shaft torque gradient becomes larger than the maximum allowable shaft torque gradient, the ECU 20 executes the torque control of the engine 1 so that the shaft torque gradient is limited to the maximum allowable shaft torque gradient. For example, the ECU 20 calculates a charging efficiency characteristic from the obtained torque characteristic, and converts it to the throttle opening degree by a physics model to set it to the throttle opening degree. Thereby, the ECU 20 executes the torque control.

By executing the control, the twist amount of the drive shaft 5 can be maintained equal to or smaller than the predetermined amount. Therefore, the repetitive shock can be suppressed, and the acceleration shock can be effectively suppressed, too.

FIG. 3 shows an example of the result of the case of executing the control according to the first embodiment. In FIG. 3, a graph shown by an actual line B1 shows a time variation of the shaft torque in the case of executing the control according to the first embodiment, and a graph shown by an actual line B2 shows an acceleration waveform in the case of executing the control according to the first embodiment. In addition, a graph shown by a broken line B3 shows the time variation of the shaft torque in the case of executing the control according to the above-mentioned comparative example, for the purpose of comparison. It is assumed that the acceleration instruction is given by the driver at time t21.

When the control according to the first embodiment is executed, it is understood that the shaft torque gradient is maintained constant, as shown by an arrow B5. This is because the obtained shaft torque gradient continuously keeps larger than the maximum allowable shaft torque gradient and the ECU 20 continuously executes the control to limit the shaft torque gradient to the maximum allowable shaft torque gradient. In addition, when the control according to the first embodiment is executed, it is understood that the shaft torque gradient is smaller than that in the case of executing the control according to the comparative example. It is understood that, by executing the control to limit the shaft torque gradient, the acceleration shock is significantly suppressed, as shown by an arrow B6. In this case, it means that, even when the twist of the drive shaft 5 changes into the repetitive shock, the twist amount satisfies the above-mentioned aimed shock amount (the amount of shock corresponding to the maximum allowable shaft torque gradient), and the amount is maintained constant. It is noted that, physically, the torque cannot be basically transmitted without the twist of the drive shaft 5.

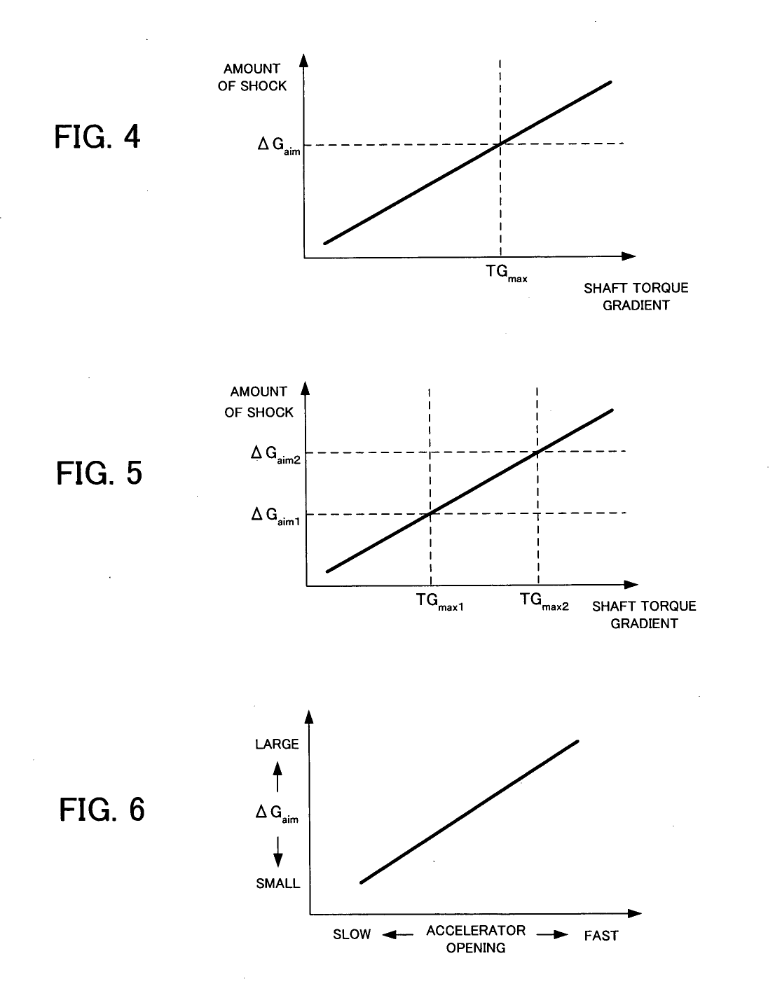

FIG. 4 shows an example of a map for determining the maximum allowable shaft torque gradient used in the control according to the first embodiment. Concretely, FIG. 4 shows an example of a map which shows a relation between the shaft torque gradient (horizontal axis) and the amount of shock occurring at the time of acceleration (vertical axis). The map of this kind is made by analyzing and measuring the drive shaft 5 mounted on the vehicle 50 in advance. The map corresponds to the characteristic (stiffness) of the drive shaft 5 mounted on the vehicle 50.

In the first embodiment, the maximum allowable amount of shock (aimed shock amount ΔGₐᵢₘ) is set first. For example, the aimed shock amount ΔGₐᵢₘ is set to “0.05G”. In the map shown in FIG. 4, the shaft torque gradient corresponding to the aimed shock amount ΔGₐᵢₘ, is set as the maximum allowable shaft torque gradient TGₘₐₓ. As described above, the ECU 20 executes the control to limit the shaft torque gradient to be equal to or smaller than the maximum allowable shaft torque gradient TGₘₐₓ with using the maximum allowable shaft torque gradient TGₘₐₓ preset based on the map. Thereby, it becomes possible to appropriately suppress the acceleration shock up to be equal to or smaller than the aimed shock amount during the acceleration.

Moreover, it also becomes possible to reduce re-adaptation process at the time of design change of the drive shaft 5 and at the time of producing a car model having the same power train, by setting the maximum allowable shaft torque gradient TGₘₐₓ with using the map. For example, when the desired shaft torque gradient is not realized as a result of obtaining the map, it is recognized that the stiffness of the drive shaft 5 is insufficient, and thus it becomes possible to give feedback to the design of the drive shaft 5.

The example of observing the shaft torque and obtaining the shaft torque gradient is given above. Namely, the example of obtaining the shaft torque gradient one by one is given above. However, the present invention is not limited to obtaining the shaft torque gradient in this manner. As another example, the shaft torque gradient can be predicted with using a transfer function. In this case, allowable the torque control of the engine 1 can be executed so that the shaft torque gradient is limited to the maximum allowable shaft torque gradient when the predicted shaft torque gradient becomes larger than the maximum allowable shaft torque gradient. When the shaft torque gradient predicted in this manner is used, the control to limit the shaft torque gradient to the maximum allowable shaft torque gradient can be executed immediately after the acceleration instruction.

In addition, the example of using the value determined by the map shown in FIG. 4 as the maximum allowable shaft torque gradient is given above, i.e., the example of using the fixed value set in advance as the maximum allowable shaft torque gradient is given above. However, the present invention is not limited to this. As another example, the maximum allowable shaft torque gradient can be changed in correspondence with engagement/release of the lockup clutch in the torque converter 2. Namely, the maximum allowable shaft torque gradient used at the time of engaging the lockup clutch is set in advance, and the maximum allowable shaft torque gradient used at the time of releasing the lockup clutch is also set in advance at the same time. Then, the maximum allowable shaft torque gradients can be switched in correspondence with the engagement/release of the lockup clutch. In this case, the maximum allowable shaft torque gradient used at the time of engaging the lockup clutch is set smaller than the maximum allowable shaft torque gradient used at the time of releasing the lockup clutch. The reason is that the acceleration shock more easily occurs at the time of engaging the lockup clutch than at the time of releasing the lockup clutch.

### SECOND EMBODIMENT

Next, a description will be given of a second embodiment of the present invention. In the second embodiment, the torque control of the engine 1 is executed so that the shaft torque gradient is maintained equal to or smaller than the maximum allowable shaft torque gradient during the acceleration, similarly to the above-mentioned first embodiment. However, the second embodiment is different from the first embodiment in that the maximum allowable shaft torque gradient is changed in correspondence with the request of the driver. Concretely, in the second embodiment, the ECU 20 uses the drive mode which the driver sets in order to adjust the drivability, as the request of the driver, and changes the maximum allowable shaft torque gradient in correspondence with the drive mode. That is, the ECU 20 changes the aimed shock amount in correspondence with the set drive mode.

A description will be given of an example of a method of changing the maximum allowable shaft torque gradient in the second embodiment with reference to FIG. 5. Now, a comfort mode and a sport mode are suggested as examples of the drive mode. For example, a switch for choosing the comfort mode or the sport mode is provided, and the driver uses the switch and adjusts the drivability.

FIG. 5 is a diagram corresponding to FIG. 4. Namely, FIG. 5 shows an example of the map showing the relation between the shaft torque gradient (horizontal axis) and the amount of shock occurring at the time of acceleration (vertical axis). The map of this kind is made in advance by analyzing and measuring the drive shaft 5 mounted on the vehicle 50.

In the comfort mode, the ECU 20 sets the maximum allowable shaft torque gradient TGₘₐₓ₁ corresponding to the aimed shock amount ΔG ₐᵢₘ₁ smaller than that set in the sport mode. For example, “0.05G” is used as the aimed shock amount ΔGₐᵢₘ₁ . Meanwhile, in the sport mode, the ECU 20 sets the maximum allowable shaft torque gradient TGₘₐₓ₂ corresponding to the aimed shock amount ΔGₐᵢₘ₂ larger than that set in the comfort mode. The value of the maximum allowable shaft torque gradient TGₘₐₓ₂ is larger than that of the maximum allowable shaft torque gradient TGₘₐₓ₁. For example, “0.1G” is used as the aimed shock amount ΔG ₐᵢₘ₂.

By switching the maximum allowable shaft torque gradients TGₘₐₓ₁ and TGₘₐₓ₂ in correspondence with the drive mode, the maximum allowable shaft torque gradient TGₘₐₓ₂ having the comparatively large value is used in the sport mode. Thus, as compared with the comfort mode, it becomes difficult to execute the control to limit the above shaft torque gradient to the maximum allowable shaft torque gradient TGₘₐₓ₂. Even when such control is executed, the shaft torque gradient is maintained at the maximum allowable shaft torque gradient TGₘₐₓ₂ having the comparatively large value. Therefore, the response to the acceleration request can be improved. In contrast, since the maximum allowable shaft torque gradient TGₘₐₓ₁ having the comparatively small value is used in the comfort mode, it is easier to execute the control to limit the above-mentioned shaft torque gradient to the maximum allowable shaft torque gradient TG_{max 1} than in the sport mode. At the same time, when the control is executed, the shaft torque gradient is maintained at the maximum allowable shaft torque gradient TGₘₐₓ₁ having the comparatively small value. Therefore, the acceleration shock can be appropriately suppressed.

According to the second embodiment, the appropriate action corresponding to the drivability requested by the driver becomes possible by changing the maximum allowable shaft torque gradient in correspondence with the drive mode chosen by the driver, i.e., by changing the aimed shock amount in correspondence with the drive mode. Namely, it becomes possible to appropriately switch whether to give a priority to the suppression of the acceleration shock or to give a priority to the improvement of the response to the acceleration request, in correspondence with the drive mode. Concretely, the acceleration shock can be appropriately suppressed in the comfort mode, and the response to the acceleration request can be improved in the sport mode. Therefore, as compared with the above-mentioned first embodiment, the optimum action becomes possible in the case of choosing the drive mode (sport mode) in which the acceleration shock is allowable and the response at the time of acceleration and the absolute speed performance are significant.

In the above manner, the example of changing the maximum allowable shaft torque gradient with using the two drive modes (i.e., the comfort mode and the sport mode) is given. However, the present invention is not limited to this. As another example, the maximum allowable shaft torque gradient can be changed in correspondence with the drive mode chosen by the driver from three or more drive modes.

Also, the present invention is not limited to changing the maximum allowable shaft torque gradient in correspondence with the drive mode. Concretely, the present invention is not limited to gradually changing the maximum allowable shaft torque gradient with gradually changing the drivability based on the choice of the drive mode. As another example, it becomes possible to enable the driver to continuously variably set the drivability and continuously change the maximum allowable shaft torque gradient in correspondence with the drivability set by the driver.

### THIRD EMBODIMENT

Next, a description will be given of a third embodiment of the present invention. In the third embodiment, the torque control of the engine 1 is also executed so that the shaft torque gradient is maintained equal to or smaller than the maximum allowable shaft torque gradient during the acceleration, similarly to the above first and second embodiments. Also, the maximum allowable shaft torque gradient is changed in correspondence with the request of the driver, similarly to the second embodiment. However, the third embodiment is different from the second embodiment in that the ECU 20 uses, as the request of the driver, the accelerator opening speed (i.e., accelerator stamping speed) and the maximum allowable shaft torque gradient is changed in correspondence with the accelerator opening speed. Namely, the ECU 20 changes the aimed shock amount in correspondence with the accelerator opening speed.

A description will be given of an example of a method of changing the maximum allowable shaft torque gradient according to a third embodiment, with reference to FIG. 6. In FIG. 6, a horizontal axis shows the accelerator opening speed (deg/ms), and a vertical axis shows the aimed shock amount ≢Gₐᵢₘ. Concretely, FIG. 6 corresponds to the map showing the aimed shock amount ΔGₐᵢₘ to be set in correspondence with the accelerator opening speed. Thereby, it is understood that, as the accelerator opening speed becomes faster, the aimed shock amount ΔGₐᵢₘ becomes larger. The map is set in consideration of the maximum accelerator opening speed in such a case that the human presses the accelerator (e.g., the speed in the fully open condition of the accelerator at 50 ms). Namely, the map is set by prescribing the maximum accelerator opening speed as the upper limit.

At the time of acceleration, the ECU 20 obtains the accelerator opening speed from the accelerator opening degree obtained by the accelerator opening degree sensor 11, and refers to the above-mentioned map to obtain the aimed shock amount ΔGₐᵢₘ corresponding to the accelerator opening speed. Then, the ECU 20 refers to the map shown in FIG. 4, and obtains the maximum allowable shaft torque gradient TGₘₐₓ corresponding to the aimed shock amount ΔGₐᵢₘ. Then, the ECU 20 executes the above-mentioned control with using the maximum allowable shaft torque gradient TGₘₐₓ. Namely, the ECU 20 executes the control to limit the shaft torque gradient to the maximum allowable shaft torque gradient TGₘₐₓ.

By changing the maximum allowable shaft torque gradient TGₘₐₓ in correspondence with the accelerator opening speed in this manner, the maximum allowable shaft torque gradient TGₘₐₓ having the comparatively large value is used when the accelerator opening speed is fast. Thus, it becomes difficult to execute the control to limit the shaft torque gradient to the maximum allowable shaft torque gradient TGₘₐₓ, as compared with such a case that the accelerator opening speed is slow. At the same time, even when the control is executed, the shaft torque gradient is maintained at the maximum allowable shaft torque gradient TGₘₐₓ having the comparatively large value. Therefore, the response to the acceleration request can be improved. In contrast, when the accelerator opening speed is slow, the maximum allowable shaft torque gradient TGₘₐₓ having the comparatively small value is used. Therefore, as compared with such a case that the accelerator opening speed is fast, it becomes easier to execute the control to limit the shaft torque gradient to the maximum allowable shaft torque gradient TGₘₐₓ. At the same time, when the control is executed, the shaft torque gradient is maintained at the maximum allowable shaft torque gradient TGₘₐₓ having the comparatively small value. Hence, the acceleration shock can be appropriately suppressed.

In the third embodiment, by changing the maximum allowable shaft torque gradient in correspondence with the accelerator opening speed of the driver, i.e., by changing the aimed shock amount in correspondence with the accelerator opening speed, it becomes possible to execute the appropriate action corresponding to the drivability requested by the driver. Namely, it becomes possible to appropriately determine whether to give a priority to the suppression of the acceleration shock or to give a priority to the improvement of the response to the acceleration request, in correspondence with the accelerator opening speed. Concretely, when the accelerator opening speed is slow, the acceleration shock can be appropriately suppressed. Meanwhile, when the accelerator opening speed is fast, the response to the acceleration request can be improved. Therefore, the driver can appropriately manage the amount of shock at the time of acceleration and the response to the acceleration request.

In the above description, the example of changing the maximum allowable shaft torque gradient in correspondence with only the accelerator opening speed is given, but the maximum allowable shaft torque gradient may be changed in correspondence with both the accelerator opening speed and the drive mode. Namely, the second and third embodiments may be combined. For example, when the accelerator opening speed is fast and the sport mode is set as the drive mode, the maximum allowable shaft torque gradient can be changed to become much larger.

### [Modification]

The above description is given of the example of executing the torque control of the engine 1 to limit the shaft torque gradient to the maximum allowable shaft torque gradient when the obtained shaft torque gradient is larger than the maximum allowable shaft torque gradient. However, the present invention is not limited to this. As another example, when the acceleration instruction is given by the driver, the torque control of the engine 1 can be executed so that the shaft torque gradient is uniformly limited to the maximum allowable shaft torque gradient. Namely, irrespective of whether or not the obtained shaft torque gradient is larger than the maximum allowable shaft torque gradient, the control can be executed so that the shaft torque gradient is set to the maximum allowable shaft torque gradient. In this case, it becomes unnecessary to gradually observe the shaft torque gradient.

The above description is also given of the example of the torque (shaft torque) operating on the drive shaft 5 as the driving-system torque, but the present invention is not limited to this. As another example, a torque operation on a propeller shaft can be used as the driving-system torque. Namely, the torque gradient of the propeller shaft can be used as the driving-system torque gradient. The reason is that the propeller shaft is also a driving-system part which is comparatively weak against and susceptible to the twist.

Moreover, the above description is given of the example of executing the torque control of the engine 1 by controlling the ignition timing and the opening of the throttle valve, but the present invention is not limited to this. As another example, when the vehicle is a hybrid vehicle, the torque control of the engine 1 can be executed by controlling the motor output and the power generation by the generator.

### INDUSTRIAL APPLICABILITY

This invention is used for a device which executes the torque control of the internal combustion engine in order to suppress the shock occurring at the time of acceleration.

1. A torque control device for an internal combustion engine which controls a torque of an internal combustion engine mounted on a vehicle, comprising:
a driving-system torque calculation unit which calculates a driving-system torque operating on a driving system for transmitting the torque of the internal combustion engine to driving wheels, based on a requested torque at a time of acceleration of the vehicle; and
a torque control unit which controls the torque of the internal combustion engine so that a gradient of the driving-system torque becomes equal to or smaller than a predetermined value, based on the driving-system torque calculated by the driving-system torque calculation unit,
wherein the driving system is formed by a drive shaft.

2. The torque control device for the internal combustion engine according to claim 1, wherein the torque control unit controls the torque of the internal combustion engine so that the gradient of the driving-system torque is limited to the predetermined value, when the gradient of the driving-system torque becomes larger than the predetermined value.

3. The torque control device for the internal combustion engine according to claim 1, further comprising a change unit which changes the predetermined value in correspondence with a request of a driver.

4. The torque control device for the internal combustion engine according to claim 3, wherein the change unit uses an accelerator opening speed as the request of the driver, and changes the predetermined value in correspondence with the accelerator opening speed.

5. The torque control device for the internal combustion engine according to claim 3, wherein the change unit uses a drive mode set by the driver as the request of the driver, and changes the predetermined value in correspondence with the drive mode.

6. The torque control device for the internal combustion engine according to claim 1, wherein the predetermined value is the gradient of the driving-system torque corresponding to a maximum allowable amount of shock in a relation between the gradient of the driving-system torque obtained in advance and an amount of shock occurring at the time of acceleration.

7. canceled
